(19) United States
(12) Patent Application Publication
(10) Pub. No.: US 2022/0032917 A1
(43) Pub. Date: Feb. 3, 2022

(54) INFORMATION PROCESSING APPARATUS, INFORMATION PROCESSING SYSTEM, NON-TRANSITORY COMPUTER READABLE MEDIUM, AND INFORMATION PROCESSING METHOD

(71) Applicant: Toyota Jidosha Kabushiki Kaisha, Toyota-shi Aichi-ken (JP)

(72) Inventors: Tae Sugimura, Miyoshi-shi Aichi-ken (JP); Kenta Miyahara, Toyota-shi Aichi-ken (JP); Shin Sakurada, Toyota-shi Aichi-ken (JP)

(21) Appl. No.: 17/388,671

(22) Filed: Jul. 29, 2021

(30) Foreign Application Priority Data
Aug. 3, 2020 (JP) 2020-132050

(51) Int. Cl. B60W 40/02; G01C 21/36; G01W 1/10

(52) U.S. Cl. CPC B60W 40/02; B60W 2555/20; G01W 1/10; G01C 21/3617

(57) ABSTRACT

An information processing apparatus includes: a communication interface configured to communicate with a terminal apparatus of a user; and a controller configured to: detect a use state of a functional component of at least one vehicle; determine weather around the at least one vehicle, based on the use state detected; select at least one facility to be recommended to the user, according to the weather determined; and transmit facility information indicating the at least one facility selected. to the terminal apparatus via the communication interface.

### CROSS-REFERENCE TO RELATED APPLICATION

This application claims priority to Japanese Patent Application No. 2020-132050, filed on Aug. 3, 2020, the entire contents of which are incorporated herein by reference.

### TECHNICAL FIELD

The present disclosure relates to an information processing apparatus, an information processing system, an information processing program, and an information processing method.

### BACKGROUND

Patent Literature (PTL) 1 describes technology for estimating, based on locations of recommended facilities determined based on a preference of a user of a vehicle, an easy-to-find recommended facility that can easily catch an eye of a passenger of the vehicle, and searching for a recommended route using the estimated easy-to-find recommended facility as a target point for any of a waypoint and a destination.

### CITATION LIST

### Patent Literature

PTL 1: JP 2014-098587 A

### SUMMARY

According to the technology described in PTL 1, a facility suitable for the weather cannot be recommended to the user.

It would be helpful to recommend a facility suitable for the weather to the user.

An information processing apparatus according to the present disclosure includes:
a communication interface configured to communicate with a terminal apparatus of a user; and
a controller configured to:
   detect a use state of a functional component of at least one vehicle; determine weather around the at least one vehicle, based on the use state detected;
   select at least one facility to be recommended to the user, according to the weather determined; and
   transmit facility information indicating the at least one facility selected, to the terminal apparatus via the communication interface.

An information processing program according to the present disclosure causes a computer to execute operations, the operations including:
detecting a use state of a functional component of at least one vehicle;
determining weather around the at least one vehicle, based on the use state detected; selecting at least one facility to be recommended to a user, according to the weather determined; and
   transmitting facility information indicating the at least one facility selected, to a terminal apparatus of the user.

An information processing method according to the present disclosure, comprises:
detecting, by an information processing apparatus, a use state of a functional component of at least one vehicle; determining, by the information processing apparatus, weather around the at least one vehicle, based on the use state detected;
selecting, by the information processing apparatus, at least one facility to be recommended to a user, according to the weather determined; and
transmitting, by the information processing apparatus, facility information indicating the at least one facility selected, to a terminal apparatus of the user.

According to the present disclosure, a facility suitable for the weather is recommended to the user.

### BRIEF DESCRIPTION OF THE DRAWINGS

In the accompanying drawings:

FIG. 1 is a diagram illustrating a configuration of an information processing system according to an embodiment of the present disclosure;

FIG. 2 is a block diagram illustrating a configuration of an information processing apparatus according to an embodiment of the present disclosure;

FIG. 3 is a block diagram illustrating a configuration of a terminal apparatus according to an embodiment of the present disclosure;

FIG. 4 is a block diagram illustrating a configuration of a vehicle according to an embodiment of the present disclosure; and

FIG. 5 is a flowchart illustrating an operation of an information processing system according to an embodiment of the present disclosure.

### DETAILED DESCRIPTION

Hereinafter, an embodiment of the present disclosure will be described with reference to the drawings.

In the drawings, the same or corresponding portions are denoted by the same reference numerals. In the descriptions of the present embodiment, detailed descriptions of the same or corresponding portions are omitted or simplified, as appropriate.

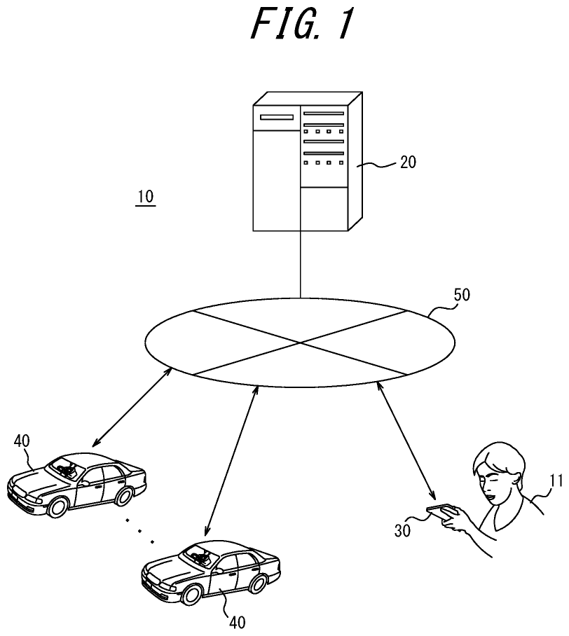

A configuration of the information processing system 10 according to the present embodiment will be described with reference to FIG. 1.

The information processing system 10 includes at least one information processing apparatus 20, at least one terminal apparatus 30, and at least one vehicle 40.

The information processing apparatus 20 can communicate with the terminal apparatus 30 and the vehicle 40 via the network 50. The vehicle 40 may be able to communicate with other vehicles 40 via the network 50.

The network 50 includes the Internet, at least one WAN, at least one MAN, or a combination thereof. The term “WAN” is an abbreviation of wide area network. The term “MAN” is an abbreviation of metropolitan area network. The network 50 may include at least one wireless network, at least one optical network, or a combination thereof. The wireless network is, for example, an ad hoc network, a cellular network, a wireless LAN, a satellite communication network, or a terrestrial microwave network. The term “LAN” is an abbreviation of local area network.

The information processing apparatus 20 is located in a facility such as a data center. The information processing apparatus 20 is, for example, a server that belongs to a crowd computing system or another computing system.

The terminal apparatus 30 is held by the user 11 in the present embodiment. Examples of the terminal apparatus 30 include a mobile apparatus such as a mobile phone, a smartphone, or a tablet, and a PC. The term “PC” is an abbreviation of personal computer.

The vehicle 40 is, for example, any type of automobile such as a gasoline vehicle, a diesel vehicle, an HV, a PHV, an EV, or an FCV. The term “HV” is an abbreviation of hybrid vehicle. The term “PHV” is an abbreviation of plug-in hybrid vehicle. The term “EV” is an abbreviation of electric vehicle. The term “FCV” is an abbreviation of fuel cell vehicle. The vehicle 40 may be a private vehicle and may be operated as a taxi or an on-demand bus. The vehicle 40 is driven by a driver in the present embodiment, but the driving may be automated at any level. The automation level is, for example, any one of Level 1 to Level 5 according to the level classification defined by SAE. The name “SAE” is an abbreviation of Society of Automotive Engineers. The vehicle 40 may be a MaaS-dedicated vehicle. The term “MaaS” is an abbreviation of Mobility as a Service.

In the present embodiment, the user 11 may either be on board or not on board the vehicle 40. When the vehicle 40 is a private vehicle, the user 11 may either be a driver or an occupant of the vehicle 40. When the vehicle 40 is a taxi or an on-demand bus, the user 11 may be a passenger of the vehicle 40.

In a modification of the present embodiment, in a case in which the user 11 is a driver, an occupant, or a passenger of the vehicle 40, the terminal apparatus 30 may be mounted or installed on the vehicle 40. That is, the terminal apparatus 30 may be included in the vehicle 40. In a case in which the terminal apparatus 30 is included in the vehicle 40, the terminal apparatus 30 may be an in-vehicle apparatus such as a car navigation device.

An outline of the present embodiment will be described with reference to FIG. 1.

In the information processing system 10 according to the present embodiment, the information processing apparatus 20 detects a use state of a functional component included in at least one vehicle 40. The information processing apparatus 20 determines weather around the vehicle 40, based on the use state detected. The information processing apparatus 20 selects at least one facility to be recommended to the user 11, according to the weather determined. The information processing apparatus 20 transmits facility information indicating the at least one facility selected, to the terminal apparatus 30 of the user 11. The terminal apparatus 30 receives the facility information from the information processing apparatus 20. The terminal apparatus 30 presents the facility information to the user 11.

According to the present embodiment, a facility suitable for the weather is recommended to the user 11.

In general, it is anticipated that the user 11 will want cold foods or drinks when the temperature is high. Thus, a facility providing cold foods or drinks is automatically recommended to the user 11, from among POIs such as restaurants. The term “POI” is an abbreviation of point of interest. Examples of the cold foods or drinks include ice cream, ice coffee, and salad.

Similarly, when the temperature is low, it is anticipated that the user 11 will want warm foods or drinks. Thus, from among POIs such as restaurants, a facility providing warm foods or drinks is automatically recommended to the user 11. Examples of the warm foods or drinks include baked potatoes, hot chocolate, and soup.

In the present embodiment, the “functional component” of the vehicle 40 is a component or unit serving a function of the vehicle 40. Examples of the “functional component” include components such as engine pistons, steering wheels, tires, transmissions, and brakes, that serve functions to perform basic performance of automobiles, such as driving, turning, and stopping, as well as auxiliary components such as various meters, wipers, in-vehicle air conditioners, and solar roofs for solar power generation.

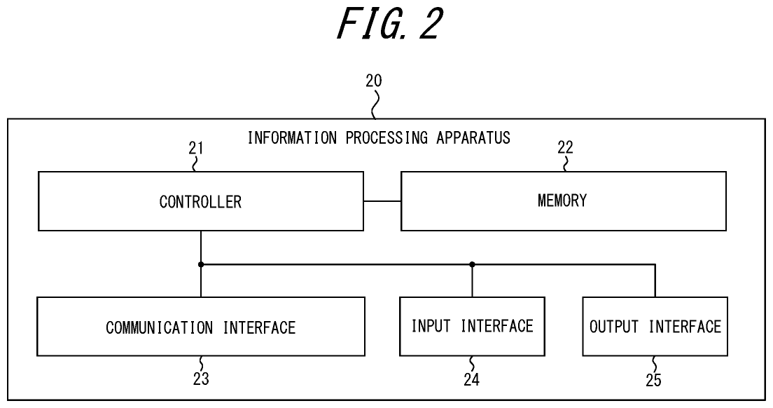

A configuration of the information processing apparatus 20 according to the present embodiment will be described with reference to FIG. 2.

The information processing apparatus 20 includes a controller 21, a memory 22, a communication interface 23, an input interface 24, and an output interface 25.

The controller 21 includes at least one processor, at least one programmable circuit, at least one dedicated circuit, or a combination thereof. The processor is a general purpose processor such as a CPU or a GPU, or a dedicated processor that is dedicated to specific processing. The term “CPU” is an abbreviation of central processing unit. The term “GPU” is an abbreviation of graphics processing unit. The programmable circuitry is, for example, an FPGA. The term “FPGA” is an abbreviation of field-programmable gate array. The dedicated circuit is, for example, an ASIC. The term “ASIC” is an abbreviation of application specific integrated circuit. The controller 21 executes processing related to the operation of the information processing apparatus 20 while controlling each component of the information processing apparatus 20.

The memory 22 includes at least one semiconductor memory, at least one magnetic memory, at least one optical memory, or a combination of at least two of these. The semiconductor memory is, for example, RAM or ROM. The term “RAM” is an abbreviation of random access memory. The term “ROM” is an abbreviation of read only memory. The RAM is, for example, SRAM or DRAM. The term “SRAM” is an abbreviation of static random access memory. The term “DRAM” is an abbreviation of dynamic random access memory. The ROM is, for example, EEPROM. The term “EEPROM” is an abbreviation of electrically erasable programmable read only memory. The memory 22 functions as, for example, a main memory, an auxiliary memory, or a cache memory. The memory 22 stores data for use in an operation of the information processing apparatus 20 and data obtained by an operation of the information processing apparatus 20.

The communication interface 23 includes at least one interface for communication. The interface for communication is, for example, a LAN interface. The communication interface 23 receives data for use in an operation of the information processing apparatus 20, and transmits data obtained by an operation of the information processing apparatus 20. In the present embodiment, the communication interface 23 performs communication with the terminal apparatus 30. The communication interface 23 also communicates with the vehicle 40.

The input interface 24 includes at least one interface for input. The interface for input is, for example, a physical key, a capacitive key, a pointing device, a touch screen integrally provided with a display, or a microphone. The input interface 24 accepts an operation to input data for use in an operation of the information processing apparatus 20. The input interface 24, instead of being included in the information processing apparatus 20, may be connected to the information processing apparatus 20 as an external input device. As the connection method, any technology such as USB, HDMI® (HDMI is a registered trademark in Japan, other countries, or both), or Bluetooth® (Bluetooth is a registered trademark in Japan, other countries, or both) can be used. The term “USB” is an abbreviation of Universal Serial Bus. The term “HDMI®” is an abbreviation of High-Definition Multimedia Interface.

The output interface 25 includes at least one interface for output. The interface for output is, for example, a display or a speaker. The display is, for example, an LCD or an organic EL display. The term “LCD” is an abbreviation of liquid crystal display. The term “EL” is an abbreviation of electro luminescence. The output interface 25 outputs data obtained by an operation of the information processing apparatus 20. The output interface 25, instead of being included in the information processing apparatus 20, may be connected to the information processing apparatus 20 as an external output device. As the connection method, any technology such as USB, HDMI®, or Bluetooth® can be used.

The functions of the information processing apparatus 20 are realized by executing the information processing program according to the present embodiment by a processor as the controller 21. That is, the functions of the information processing apparatus 20 are realized by software. The information processing program causes the computer to function as the information processing apparatus 20 by causing the computer to execute operations of the information processing apparatus 20. That is, the computer functions as the information processing apparatus 20 by executing the operations of the information processing apparatus 20 in accordance with the information processing program.

The program can be stored on a non-transitory computer readable medium. The non-transitory computer readable medium is, for example, flash memory, a magnetic recording device, an optical disc, a magneto-optical recording medium, or ROM. The program is distributed, for example, by selling, transferring, or lending a portable medium such as an SD card, a DVD, or a CD-ROM on which the program is stored. The term “SD” is an abbreviation of Secure Digital. The term “DVD” is an abbreviation of digital versatile disc. The term “CD-ROM” is an abbreviation of compact disc read only memory. The program may be distributed by storing the program in a storage of a server and transferring the program from the server to another computer. The program may be provided as a program product.

For example, the computer temporarily stores, in a main memory, a program stored in a portable medium or a program transferred from a server. Then, the computer reads the program stored in the main memory using a processor, and executes processing in accordance with the read program using the processor. The computer may read out a program directly from the portable medium and execute processing according to the program. The computer may execute processing according to the received program in order each time a program is transferred from a predetermined server to the computer. The processing may be executed through a so-called ASP-type service which implements functions merely by execution of instructions and acquisition of results, without transferring the program from the predetermined server to the computer. The term “ASP” is an abbreviation of application service provider. Programs encompass information for use in processing by a computer, equivalent to a program. For example, data which is not a direct instruction to a computer but has properties that define the processing of the computer corresponds to the “information equivalent to a program” in this context.

Some or all of the functions of the information processing apparatus 20 may be realized by a programmable circuit or a dedicated circuit as the controller 21. That is, some or all of the functions of the information processing apparatus 20 may be realized by hardware.

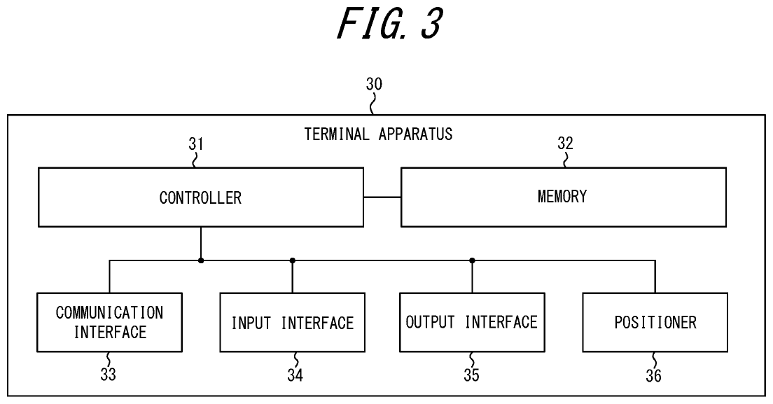

A configuration of the terminal apparatus 30 according to the disclosed embodiment is explained with reference to FIG. 3.

The terminal apparatus 30 includes: a controller 31; a memory 32; a communication interface 33; an input interface 34; an output interface 35; and a positioner 36.

The controller 31 includes at least one processor, at least one programmable circuit, at least one dedicated circuit, or a combination thereof.

The processor is a general purpose processor such as a CPU or a GPU, or a dedicated processor that is dedicated to specific processing. The programmable circuit is, for example, an FPGA. The dedicated circuit is, for example, an ASIC. The controller 31 controls each component of the terminal apparatus 30 to execute processing related to the operations of the terminal apparatus 30.

The memory 32 includes at least one semiconductor memory, at least one magnetic memory, at least one optical memory, or a combination of at least two of these. The semiconductor memory is, for example, RAM or ROM. The RAM is, for example, SRAM or DRAM. The ROM is, for example, EEPROM. The memory 32 functions as, for example, a main memory, an auxiliary memory, or a cache memory. The memory 32 stores data for use in an operation of the terminal apparatus 30 and data obtained by an operation of the terminal apparatus 30.

The communication interface 33 includes at least one interface for communication. The interface for communication is, for example, an interface corresponding to a mobile communication standard such as LTE, the 4G standard, or the 5G standard, an interface corresponding to a near field communication standard such as Bluetooth®, or a LAN interface. The term “LTE” is an abbreviation of Long Term Evolution. The term “4G” is an abbreviation of 4th generation. The term “5G” is an abbreviation of 5th generation. The communication interface 33 receives data for use in an operation of the terminal apparatus 30, and transmits data obtained by an operation of the terminal apparatus 30.

The input interface 34 includes at least one interface for input. The interface for input is, for example, a physical key, a capacitive key, a pointing device, a touch screen integrally provided with a display, or a microphone. The input interface 34 accepts an operation to input data for use in an operation of the terminal apparatus 30. The input interface 34, instead of being included in the terminal apparatus 30, may be connected to the terminal apparatus 30 as an external input device. As the connection method, any technology such as USB, HDMI®, or Bluetooth® can be used.

The output interface 35 includes at least one interface for output. The interface for output is, for example, a display or a speaker. The display is, for example, an LCD or an organic EL display. The output interface 35 outputs data obtained by an operation of the terminal apparatus 30. The output interface 35, instead of being included in the terminal apparatus 30, may be connected to the terminal apparatus 30 as an external output device. As the connection method, any technology such as USB, HDMI®, or Bluetooth® can be used.

The positioner 36 includes at least one GNSS receiver. The term “GNSS” is an abbreviation of global navigation satellite system. GNSS is, for example, GPS, QZSS, BeiDou, GLONASS, or Galileo. The term “GPS” is an abbreviation of Global Positioning System. The term “QZSS” is an abbreviation of Quasi-Zenith Satellite System. QZSS satellites are called quasi-zenith satellites. The term “GLONASS” is an abbreviation of Global Navigation Satellite System. The positioner 36 measures the position of the terminal apparatus 30.

The functions of the terminal apparatus 30 are realized by executing an arbitrary terminal program by a processor as the controller 31. In other words, the functions of the terminal apparatus 30 are realized by software. The terminal program causes a computer to execute operations of the terminal apparatus 30, to thereby cause the computer to function as the terminal apparatus 30. In other words, the computer executes operations of the terminal apparatus 30 according to the terminal program, to thereby function as the terminal apparatus 30.

Some or all of the functions of the terminal apparatus 30 may be realized by a programmable circuit or a dedicated circuit as the controller 31. That is, some or all of the functions of the terminal apparatus 30 may be realized by hardware.

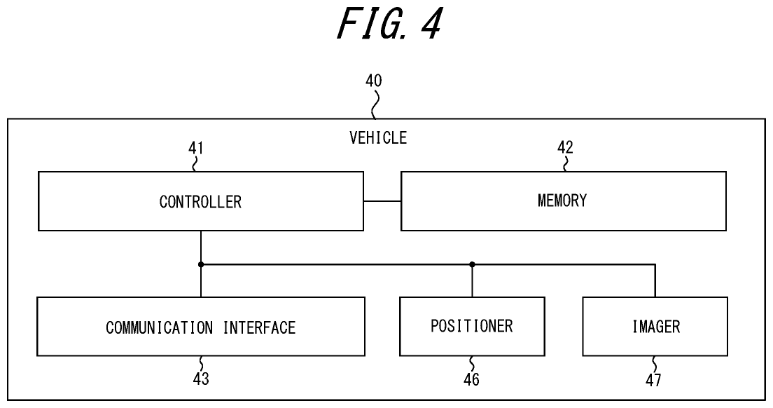

Referring to FIG. 4, a configuration of the vehicle 40 according to the present embodiment will be described.

The vehicle 40 includes a controller 41, a memory 42, a communication interface 43, a positioner 46, and an imager 47.

The controller 41 includes at least one processor, at least one programmable circuit, at least one dedicated circuit, or a combination thereof. The processor is a general purpose processor such as a CPU or a GPU, or a dedicated processor that is dedicated to specific processing. The programmable circuitry is, for example, an FPGA. The dedicated circuit is, for example, an ASIC. The controller 41 executes processing related to the operation of the vehicle 40 while controlling each functional component of the vehicle 40.

The memory 42 includes at least one semiconductor memory, at least one magnetic memory, at least one optical memory, or a combination of at least two of these. The semiconductor memory is, for example, RAM or ROM. The RAM is, for example, SRAM or DRAM. The ROM is, for example, EEPROM. The memory 42 functions as, for example, a main memory, an auxiliary memory, or a cache memory. The memory 42 stores data for use in an operation of the vehicle 40, and data obtained by an operation of the vehicle 40.

The communication interface 43 includes at least one interface for communication. The interface for communication is, for example, a LAN interface. The communication interface 43 receives the data for use in an operation of the vehicle 40 and also transmits the data obtained by an operation of the vehicle 40.

The positioner 46 includes at least one GNSS receiver. GNSS may be, for example, GPS, QZSS, BeiDou, GLONASS, or Galileo. The positioner 46 measures the position of the vehicle 40.

The imager 47 includes an in-vehicle camera for generating a moving image obtained by imaging a subject in the field of view. The moving image includes a plurality of still images captured at a predetermined frame rate, for example, 30 fps. Hereinafter, each of the plurality of still images is also referred to as a frame. The in-vehicle camera may be a monocular camera or a stereo camera. For example, an electronic device having a camera function, such as a drive recorder or a smart phone used by an occupant, may function as the imager 47.

The functions of the vehicle 40 are realized by executing an arbitrary vehicle program by a processor as the controller 41. That is, the functions of the vehicle 40 are realized by software. The vehicle program causes the computer to function as the vehicle 40 by causing the computer to execute operations of the vehicle 40. That is, the computer functions as the vehicle 40 by performing the operation of the vehicle 40 according to the vehicle program.

Some or all of the functions of the vehicle 40 may be realized by programmable circuitry or dedicated circuitry as the controller 41. That is, some or all of the functions of the vehicle 40 may be realized by hardware.

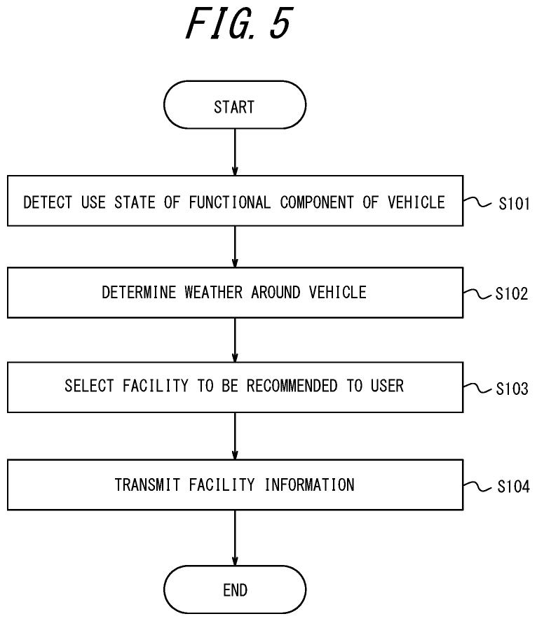

Operations of the information processing system 10 according to the present embodiment will be described with reference to FIG. 5. These operations correspond to the information processing method according to the present embodiment.

In Step S101, the controller 21 of the information processing apparatus 20 detects a use state of a functional component of at least one vehicle 40. The use state of the functional component may be detected by any method. As one method, the controller 21 of the information processing apparatus 20 receives, via the communication interface 23 of the information processing apparatus 20, information indicating the result of monitoring the functional component of the vehicle 40 by the controller 41 of the vehicle 40. The controller 21 of the information processing apparatus 20 detects the use state of the functional component based on the result indicated by the received information.

In the present embodiment, the controller 21 of the information processing apparatus 20 detects a power generation amount of a solar roof of the at least one vehicle 40 as the use state of the functional component. The power generation amount of the solar roof may be detected by any method.

As one method, the controller 41 of the vehicle 40 monitors the operating state of the solar roof and calculates, for example, the amount of power generated per unit area. The controller 41 transmits information indicating the power generation amount calculated, to the information processing apparatus 20, via the communication interface 43 of the vehicle 40. The information processing apparatus 20 receives, via the communication interface 23, the information indicating the power generation amount transmitted from the vehicle 40.

In Step S102, the controller 21 of the information processing apparatus 20 determines the weather around the at least one vehicle 40, based on the use state detected in Step S101. In the present embodiment, in a case in which the power generation amount of the solar roof detected in Step S101 is equal to or greater than the threshold value, the controller 21 of the information processing apparatus 20 determines that the weather is fine in Step S102. Specifically, the controller 21 of the information processing apparatus 20 compares the power generation amount indicated by the information received in Step S101 with a threshold value, and determines that the weather is fine when the power generation amount is equal to or greater than the threshold value.

In Step S103, the controller 21 of the information processing apparatus 20 selects at least one facility to be recommended to the user 11, according to the weather determined in Step S102. For example, suppose that the weather is determined as fine in Step S102. In general, in a case in which the weather is fine, it is anticipated that the user 11 will prefer an outdoor facility over an indoor facility. Therefore, the controller 21 of the information processing apparatus 20 selects an outdoor facility as the at least one facility to be recommended to the user 11.

In Step S104, the controller 21 of the information processing apparatus 20 transmits the facility information indicating the facility selected in Step S103, to the terminal apparatus 30 via the communication interface 23. The facility information is information for identifying the selected facility. In the present embodiment, the facility information includes information indicating the name, location, route to the location, availability, and contact information for the facility. The controller 21 transmits the facility information to the terminal apparatus 30 via the communication interface 23.

The controller 31 of the terminal apparatus 30 receives the facility information transmitted from the information processing apparatus 20 via the communication interface 33, and displays the facility information on the output interface 35 such as a display. The name, location, route to the location, availability, and contact information for the facility indicated by the facility information are displayed, for example, in text on the output interface 35.

As described above, the controller 21 of the information processing apparatus 20 performs the processing from Step S101 to Step S104 to detect the use state of a functional component of at least one vehicle 40 based on the use state detected, determine the weather around the at least one vehicle 40, select at least one facility to be recommended to the user 11 according to the weather determined, and transmit the facility information indicating the at least one facility selected, to the terminal apparatus 30 via the communication interface 23.

According to the present embodiment, a facility suitable for the weather can be recommended to the user 11.

The present disclosure is not limited to the embodiment described above. For example, a plurality of blocks described in the block diagrams may be integrated, or a block may be divided. Instead of executing a plurality of steps described in the flowcharts in chronological order in accordance with the description, the plurality of steps may be executed in parallel or in a different order according to the processing capability of the apparatus that executes each step, or as required. Other modifications can be made without departing from the spirit of the present disclosure.

As a modification of the present embodiment, in Step S101, the controller 21 of the information processing apparatus 20 may detect, as the use state of the functional component, a use state of a functional component of at least one vehicle 40 traveling in a vicinity of a destination of the user 11. In Step S102, the controller 21 determines, as the weather to be determined, the weather around at least one vehicle 40 traveling in the vicinity of the destination. In Step S103, the controller 21 selects, as the facility to be recommended to the user 11, at least one facility that is present in the vicinity of the destination.

The “destination” refers to a specific place or region that the user 11 is planning to visit. Examples of the “destination” include recreational areas such as nature parks, amusement parks, zoos, aquariums, and athletic facilities, and tourist attractions such as ruins, temples, shrines, or hot spring villages. The destination information for the user 11 may be acquired by any method. In the present modification, the terminal apparatus 30 accepts an operation made by the user 11 to select a destination. The communication interface 23 of the information processing apparatus 20 communicates with the terminal apparatus 30, and receives the destination information transmitted from the terminal apparatus 30. In the present embodiment, the destination information is information indicating the destination of the user 11 who is to be delivered to the destination by the vehicle 40. The destination information indicates the name, address, or location of the destination selected by the user 11. The location is indicated by, for example, two-dimensional coordinates or three-dimensional coordinates. The controller 21 of the information processing apparatus 20 acquires the destination information received by the communication interface 23.

According to the present modification, the facility suitable for the weather at the destination of the user 11 is recommended, and thus the user 11 can easily plan activities the behavior at the destination.

As a modification of the present embodiment, the controller 21 of the information processing apparatus 20 may acquire positional information indicating the position of the user 11. In this case, in Step S101, the controller 21 detects, as the use state of the functional component, a use state of a functional component of at least one vehicle 40 that travels in the vicinity of the position of the user 11. In Step S102, the controller 21 determines, as the weather to be determined, the weather around at least one vehicle 40 traveling in the vicinity of the position of the user 11. In Step

S103, the controller 21 selects at least one facility that is present in the vicinity of the position of the user 11, as the facility to be recommended to the user 11.

The positional information for the user 11 may be obtained by any method. In the present modification, the controller 21 of the information processing apparatus 20 acquires, as the positional information for the user 11, positional information indicating a position measured by the positioner 36 of the terminal apparatus 30 of the user 11. Alternatively, in a case in which the user 11 is a driver, an occupant, or a passenger of the vehicle 40, the controller 21 may acquire, as the positional information for the user 11, the positional information indicating the position measured by the positioner 46 of the vehicle 40.

According to the present modification, in a case in which the user 11 thinks of stopping somewhere on the way to the destination, a facility suitable for the weather of the place to be stopped can be recommended to the user 11.

As a modification of the present embodiment, in Step S101, the controller 21 of the information processing apparatus 20 may detect, as the use state of the functional component, whether an operation of an in-vehicle air conditioner of the at least one vehicle 40 is cooling or heating. When the operation of the in-vehicle air conditioner is cooling, the controller 21 determines, as the weather to be determined in Step S102, that the temperature is high. When the operation of the in-vehicle air conditioner is heating, the controller 21 determines, as the weather to be determined in Step S102, that the temperature is low.

The operation of the in-vehicle air conditioner of the vehicle 40 may be detected by any method. In the present modification, the controller 41 of the vehicle 40 monitors the operating state of the in-vehicle air conditioner, and detects whether the operation mode is cooling or heating. The controller 41 transmits information indicating the detected operation mode to the information processing apparatus 20 via the communication interface 43 of the vehicle 40. The information processing apparatus 20 receives the information indicating the operation mode, transmitted from the vehicle 40 via the communication interface 23.

According to the present modification, a facility that provides hot meals can be recommended to the user 11 when it is cold with lower temperature, and a facility that provides cold meals can be recommended to the user 11 when it is hot with higher temperature.

As a modification of the present embodiment, the controller 21 of the information processing apparatus 20 may determine, in Step S102, that the weather is rain when tire slippage of the at least one vehicle 40 is detected as the use state of the functional component in Step S101.

Tire slippage of the vehicle 40 may be detected by any method. In the present modification, the controller 41 of the vehicle 40 acquires information indicating physical quantities such as the tire rotational speed and the vehicle speed of the vehicle 40, and transmits the acquired information to the information processing apparatus 20 via the communication interface 43 of the vehicle 40. The controller 21 of the information processing apparatus 20 receives the information transmitted from the vehicle 40 via the communication interface 23. The controller 21 detects tire slippage based on the physical quantities such as the tire rotational speed and the vehicle speed of the vehicle 40 indicated by the received information.

In general, a road surface is known to be slippery at the beginning of rain. According to the present modification, rain can be detected at the beginning, and thus, even when the weather has suddenly changed, a facility suitable for the weather thus changed can be recommended to the user 11.

As a modification of the present embodiment, in Step S101, the controller 21 of the information processing apparatus 20 determines, as the use state of the functional component, whether a wiper of the at least one vehicle 40 is used. When the wiper is used, the controller 21 determines that the weather is rain in Step S102.

Whether the wiper of the vehicle 40 is being used may be detected by any method. In the present modification, the controller 41 of the vehicle 40 monitors the operating state of the wiper, and detects whether the wiper is operating. When the controller 41 has detected that the wiper is operating, the controller 41 transmits information indicating that the wiper is being used, to the information processing apparatus 20 via the communication interface 43 of the vehicle 40. The information processing apparatus 20 receives the information transmitted from the vehicle 40, via the communication interface 23.

In general, when the weather is rain, it is expected that the user 11 will prefer an indoor facility over an outdoor facility. In order to avoid getting wet from the rain while waiting to enter the facility, it is expected that the user 11 will prefer a facility with less waiting time. According to the present modification, when the weather is rain, an indoor facility or a facility with less outside waiting time can be recommended to the user 11.

As a modification of the present embodiment, the controller 21 of the information processing apparatus 20 may acquire profile information indicating a preference of the user 11, and select at least one facility to be recommended to the user 11 according to the weather around the vehicle 40 and the preference of the user 11. In the present modification, the “profile information indicating a preference of the user 11” is information indicating the preference of the user 11 to various facilities as the POIs. The profile information for the user 11 may be acquired by any method. In the present modification, the controller 21 of the information processing apparatus 20 estimates the preference of the user 11 based on the history of activities of the user 11 or the website browsing history of the user 11, and acquires the result of estimation as the profile information. Alternatively, the controller 21 may acquire the profile information by referring to, for example, an arbitrary database in which the preference of the user 11 is registered in advance.

The profile information indicates, as the preference of the user 11 for food-serving facilities as the POIs, for example, the genre of food ingredients or cooking preferred by the user 11, whether the user 11 prefers local meals, the dietary restrictions being made by the user 11, the food allergy of the user 11 to a specific food, and the budget desired by the user 11. Further, the profile information may indicate, as the preference of the user 11 for entertainment facilities as the POIs, for example, whether the user 11 prefers outdoor activities or indoor activities. Alternatively, the profile information may indicate, as the preference of the user 11 for accommodation facilities as the POIs, for example, the room type, budget, or accommodation plan desired by the user 11, or the benefits or privileges to be provided to the user 11 by a particular accommodation facility.

In the present modification, suppose that the profile information for the user 11 indicates, as the preference of the user 11 for entertainment facilities as the POIs, that the user 11 prefers outdoor activities. Suppose that the profile information for the user 11 indicates, as the preference of the user 11 for food-serving facilities as POIs, that the user 11 prefers local meals. Suppose that the weather around the vehicle 40 is determined as rain. In this case, the controller 21 of the information processing apparatus 20 selects, as a facility to be recommended to the user 11, an indoor barbecue facility to which local ingredients are provided.

According to the present modification, a facility suitable for both the preference of the user 11 and the weather is recommended to the user 11.

1. An information processing apparatus, comprising:
a communication interface configured to communicate with a terminal apparatus of a user; and
a controller configured to:
detect a use state of a functional component of at least one vehicle;
determine weather around the at least one vehicle, based on the use state detected;
select at least one facility to be recommended to the user, according to the weather determined; and
transmit facility information indicating the at least one facility selected, to the terminal apparatus via the communication interface.

2. The information processing apparatus according to claim 1, wherein the controller detects a power generation amount of a solar roof of the at least one vehicle, as the use state of the functional component, and determines that the weather is fine when the power generation amount is equal to or greater than a threshold value.

3. The information processing apparatus according to claim 1, wherein the controller detects, as the use state of the functional component, whether an operation of an in-vehicle air conditioner of the at least one vehicle is cooling or heating, determines, as the weather to be determined, that an air temperature is high when the operation of the in-vehicle air conditioner is cooling, and determines, as the weather to be determined, that an air temperature is low when the operation of the in-vehicle air conditioner is heating.

4. The information processing apparatus according to claim 1, wherein the controller determines that the weather is rain when tire slippage of the at least one vehicle is detected as the use state of the functional component.

5. The information processing apparatus according to claim 1, wherein the controller determines, as the use state of the functional component, whether a wiper of the at least one vehicle is used, and determines that the weather is rain when the wiper is used.

6. The information processing apparatus according to claim 1, wherein the at least one vehicle is a vehicle traveling in a vicinity of a destination of the user.

7. The information processing apparatus according to claim 6, wherein the at least one facility is a facility that is present in the vicinity of the destination.

8. The information processing apparatus according to claim 1, wherein:
the controller further acquires positional information indicating a position of the user; and
the at least one vehicle is a vehicle traveling in a vicinity of the position of the user.

9. The information processing apparatus according to claim 8, wherein the at least one facility is a facility that is present in the vicinity of the position of the user.

10. The information processing apparatus according to claim 1, wherein the controller acquires profile information indicating a preference of the user, and selects at least one facility to be recommended to the user, according to the weather and the preference.

11. An information processing system, comprising:
the information processing apparatus according to claim 1; and
a terminal apparatus configured to receive the facility information from the information processing apparatus.

12. A non-transitory, computer readable medium storing an information processing program that causes a computer to execute operations, the operations including:
detecting a use state of a functional component of at least one vehicle;
determining weather around the at least one vehicle, based on the use state detected;
selecting at least one facility to be recommended to a user, according to the weather determined; and
transmitting facility information indicating the at least one facility selected, to a terminal apparatus of the user.

13. The non-transitory computer readable medium according to claim 12, wherein the at least one vehicle is a vehicle traveling around a destination of the user.

14. The non-transitory computer readable medium according to claim 13, wherein the at least one facility is a facility that is present around the destination.

15. The non-transitory computer readable medium according to claim 12, wherein
the operations further comprise obtaining positional information that indicates a position of the user, and
the at least one vehicle is a vehicle traveling around the position of the user.

16. The non-transitory computer readable medium according to claim 15, wherein the at least one facility is a facility that is present around the position of the user.

17. An information processing method comprising:
detecting, by an information processing apparatus, a use state of a functional component of at least one vehicle;
determining, by the information processing apparatus, weather around the at least one vehicle, based on the use state detected;
selecting, by the information processing apparatus, at least one facility to be recommended to a user, according to the weather determined; and
transmitting, by the information processing apparatus, facility information indicating the at least one facility selected, to a terminal apparatus of the user.

18. The information processing method according to claim 17, wherein the at least one vehicle is a vehicle traveling around a destination of the user.

19. The information processing method according to claim 17, further comprising acquiring, by the information processing apparatus, positional information indicating a position of the user,
wherein the at least one vehicle is a vehicle traveling around the position of the user.

20. The information processing method according to claim 17, further comprising acquiring, by the information processing apparatus, profile information indicating a preference of the user,
wherein the selecting comprises selecting at least one facility according to the weather and the preference.
